(19) United States
(12) Patent Application Publication
(10) Pub. No.: US 2025/0344869 A1
(43) Pub. Date: Nov. 13, 2025

(54) FOLD-DOWN WALL BED, METHOD OF BALANCING A FOLD-DOWN WALL BED, AND SPRING-ASSISTED LIFT ASSEMBLY THEREFOR

(71) Applicant: Mark S. Mossell, Portage, IN (US)

(72) Inventor: Mark S. Mossell, Portage, IN (US)

(21) Appl. No.: 19/039,406

(22) Filed: Jan. 28, 2025

Related U.S. Application Data
(60) Provisional application No. 63/643,776, filed on May 7, 2024.

(51) Int. Cl. A47C 17/40; A47B 81/06; A47C 19/22; A47C 21/02

(52) U.S. Cl. CPC A47C 17/40; A47C 19/22; A47C 21/026; A47B 81/06

(57) ABSTRACT

Fold-down wall beds, lift assemblies for fold-down beds, and associated methods. Such a wall bed includes a bed frame and at least one spring-assisted lift assembly that pivots the frame about a lateral axis between closed and open positions of the frame. A closing force exerted by the spring-assisted lift assembly to pivot the bed frame about the lateral axis can be adjusted by adding or removing springs to the spring-assisted lift assembly after the wall bed has been installed for use. This allows the closing force to be readily balanced to accommodate beds of different sizes and/or weights such that the closing force assists rotating the bed frame up from the open position to the closed position.

### CROSS-REFERENCE TO RELATED APPLICATIONS

This application claims the benefit of provisional U.S. Patent Application No. 63/643,776 filed May 7, 2024, the contents of which are incorporated herein by reference.

### BACKGROUND OF THE INVENTION

The invention generally relates to a fold-down wall bed, components thereof, and methods related thereto.

A fold-down wall bed, or simply a wall bed (also known as a Murphy bed), is a bed that is stored in an upright (e.g., vertical) position against a wall and can be folded, that is pivoted, down into a horizontal open position on a floor (e.g., the floor of the van cargo area) when needed for sleeping. When it is desired to use the floor space for other purposes, the bed can be folded back up into the upright closed position against the wall and secured in the closed position. A wall bed is typically used to provide a bed in an area where space is at a premium and it is desired to be able to use the floor space for other purposes when the bed is not needed.

Wall beds are commonly used in homes where there is typically plenty of space for a person to position themselves advantageously to pivot the bed up and/or down. However, in a mobile setting, such as in automobile (e.g., a recreational vehicle (RV) or cargo van), boat, or airplane, there may not be sufficient space for a person to position themselves in the best position needed to easily raise and/or lower the bed. This can make it difficult for people with more limited physical capabilities to operate the wall bed. Therefore, it would be desirable to have a fold-down wall bed with an improved lift mechanism to make it easier to be pivoted up and/or down, particularly in mobile vehicular applications such as in RVs or vans.

In addition, although some conventional wall beds may have cabinetry of various designs, they typically do not house a tippable cabinet or have an electronics housing or track table that could be used when the bed is in its upright position (e.g., pivoted vertically adjacent a wall). Therefore, it would be desirable to have a fold-down wall bed that includes a table, electronics housing, and/or track table that can be opened and used when the wall bed is in its upright position.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, fold-down wall beds, spring-assisted lift assemblies for fold-down beds, and associated methods.

According to a nonlimiting aspect, a fold-down wall bed includes a bed frame that pivots about a lateral axis near a head end of the bed frame between an upright closed position and a horizontal open position. A spring-assisted lift assembly pivots the bed frame about the lateral axis between the closed position and the open position. A closing force exerted by springs in the spring-assisted lift assembly to pivot the bed frame about the lateral axis can be adjusted by adding or removing springs to the spring-assisted lift assembly after the fold-down wall bed has been installed for use.

According to another nonlimiting aspect, a spring-assisted lift assembly is provided for pivoting a bed frame of a fold-down wall bed about a lateral axis between a closed position and an open position. The assembly includes a first spring anchor bracket pivotably mounted on a first lug to be secured to the bed frame, a second spring anchor bracket pivotably mounted on a second lug secured to a support leg, and one or more springs extending between and releasably mounted to each of the first spring anchor bracket and the second spring anchor bracket. The one or more springs urge the first lug travel in an arcuate path about the lateral axis for moving the bed frame from the horizontal open position toward the upright closed position. A closing force exerted by springs in the spring-assisted lift assembly can be adjusted by adding or removing springs to the spring-assisted lift assembly.

According to another nonlimiting aspect, a method of balancing a fold-down wall bed as described above includes adding or removing springs to the spring-assisted lift assembly to balance the closing force such that the closing force is sufficient to rotate the bed frame up from the open position to the closed position without additional force after the bed frame has pivoted past a tangent position on an arc of a guide slot but not sufficient to rotate the bed frame up to the tangent position from the horizontal open position without some additional starting force.

Technical aspects of a fold-down wall bed as described above preferably include the ability to promote their ease and safety of operation.

These and other aspects, arrangements, features, and/or technical effects will become apparent upon detailed inspection of the figures and the following description.

### BRIEF DESCRIPTION OF THE DRAWINGS

FIG. 1 is an isometric view of a fold-up wall bed installed in the cargo space of a van with the bed frame folded up in an upright, closed storage position according to a nonlimiting aspect of the invention.

FIG. 2 is an isometric view of the wall with the bed frame folded down in a horizontal open sleep position.

FIG. 3 is a side view of a lift assembly for the wall bed with the bed frame folded down in the open horizontal sleep position.

FIG. 4 is a side view of the lift assembly with the bed frame folded up in the closed upright storage position.

FIG. 5 is an isometric view of the lift assembly in the open horizontal sleep position from the opposite side.

FIG. 6 is a vertical cross-sectional view of the lift assembly in the open horizontal sleep position.

FIG. 7 is a side view of an alternative embodiment of the lift assembly according to another nonlimiting aspect of the invention with the bed frame pivoted up in the closed upright storage position showing hidden features for clarity.

FIG. 8 is a cross-sectional view of the wall bed in the open horizontal sleep position.

FIGS. 9A through 9C are enlarged detail cross-sectional views of a folding night shelf as seen in FIG. 8 in a storage position (FIG. 9A), an intermediate position (FIG. 9B), and a use position (FIG. 9C).

FIG. 10 is an isometric view of the wall bed in the upright position and with a fold-out table in an open position.

FIG. 11 is a cross-sectional view of the wall bed and fold-out table in the position of FIG. 10.

FIGS. 12A through 12C are enlarged cross-sectional detail views of the fold-out table in the open position (FIG. 12A), an intermediate folded position (FIG. 12B), and a folded-closed position (FIG. 12C).

FIG. 13 is an isometric view of the wall bed in the upright position and with cabinet doors open to show interior portions of the cabinets.

FIG. 14 is a detail view of a locking mechanism for locking the bed frame in the closed position.

### DETAILED DESCRIPTION OF THE INVENTION

The intended purpose of the following detailed description of the invention and the phraseology and terminology employed therein is to describe what is shown in the drawings, which include the depiction of and/or relate to one or more nonlimiting embodiments of the invention, and to describe certain but not all aspects of the embodiment(s) to which the drawings relate. The following detailed description also identifies certain but not all alternatives of the embodiment(s). As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to particularly point out subject matter regarded to be aspects of the invention, including certain but not necessarily all of the aspects and alternatives described in the detailed description.

Although the invention will be described hereinafter in reference to a wall bed installed in a van or RV as shown in the drawings, it will be appreciated that the teachings of the invention are more generally applicable to a variety of types of installed use environments, such as, but not limited to, trains, airplanes, automobiles, trailers, trucks, ships, boats, space craft, and other types of mobile vehicles, as well as a house, cabin, apartment, or other fixed (i.e., non-mobile) dwelling space.

To facilitate the description provided below of the embodiment(s) represented in the drawings, relative terms, including but not limited to, “proximal,” “distal,” “anterior,” “posterior,” “vertical,” “horizontal,” “lateral,” “front,” “rear,” “side,” “forward,” “rearward,” “top,” “bottom,” “upper,” “lower,” “above,” “below,” “right,” “left,” etc., may be used in reference to the orientation of the fold-down bed and/or its components during its use and/or as represented in the drawings. All such relative terms are useful to describe the illustrated embodiment(s) but should not be otherwise interpreted as limiting the scope of the invention.

As used herein the terms “a” and “an” to introduce a feature are used as open-ended, inclusive terms to refer to at least one, or one or more of the features, and are not limited to only one such feature unless otherwise expressly indicated. Similarly, use of the term “the” in reference to a feature previously introduced using the term “a” or “an” does not thereafter limit the feature to only a single instance of such feature unless otherwise expressly indicated.

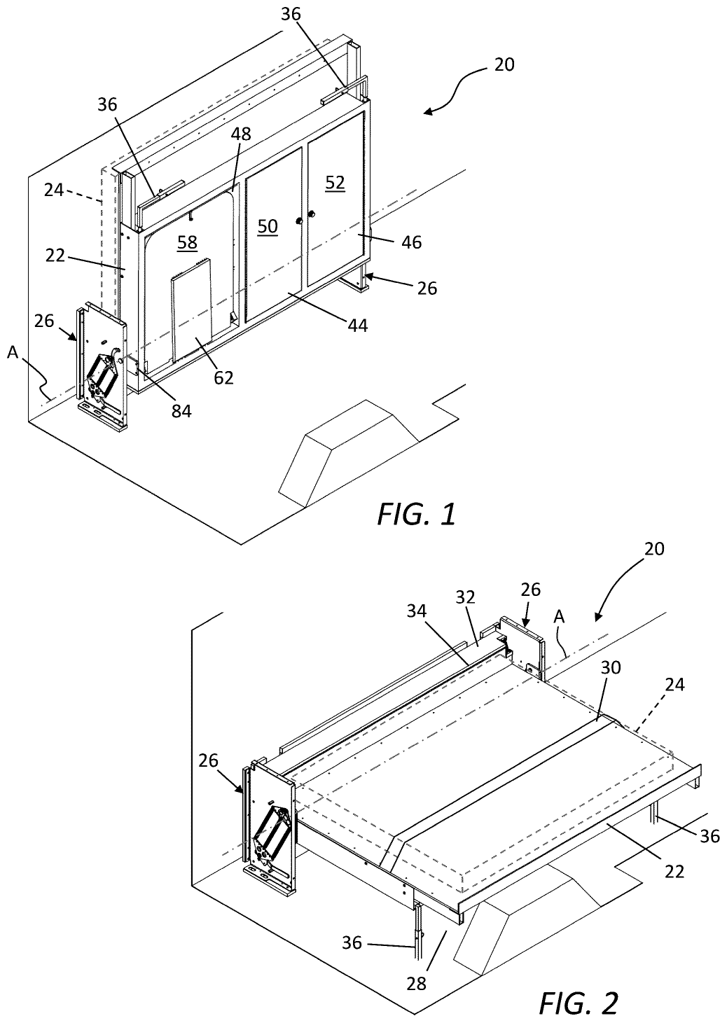

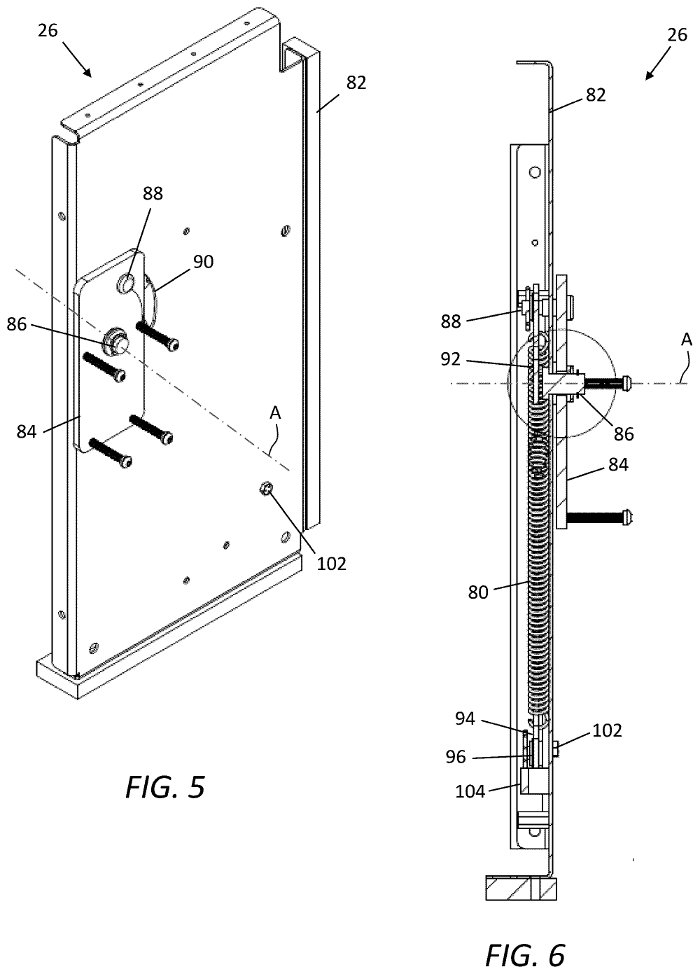

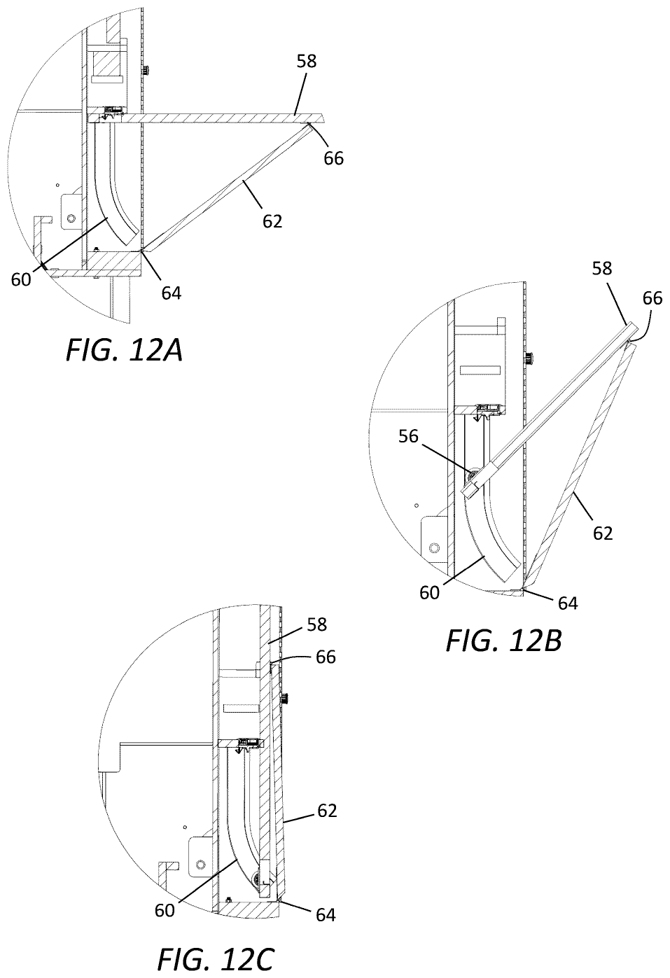

FIGS. 1-13 illustrate example embodiments of a fold-down wall bed 20 (also sometimes called a Murphy bed) embodying certain nonlimiting aspects of the invention. In this example, the wall bed 20 is specifically configured for installation in a van or recreational vehicle (RV). The wall bed 20 has a closed position, as best seen in FIG. 1, in which the bed frame 22 and mattress 24 disposed on a top side of the bed frame 22 are in folded upright, substantially vertical position. The wall bed 20 also has an open position, as best seen in FIGS. 2, in which the bed frame 22 and mattress 24 are in a folded-down, substantially horizontal position. The bed frame 22 may be provided in any convenient size to accommodate various mattress sizes, such as a standard king, queen, double, twin, or other size. In some nonlimiting examples, the bed frame 22 is sized to accommodate either a queen size mattress or a double size mattress. In some embodiments, the bed frame 22 may include one or more platform extensions that can be easily altered to accommodate mattresses of different widths and/or lengths.

The bed frame 22 (and mattress 24 if on the bed frame 22) pivots between the closed position and the open position around a pivot axis A at the head end of the bed frame 22. As used herein, the terms “head end” and “foot end” are not intended as limitations, but merely to help identify the opposite ends of the bed frame 22 and mattress 24 as it is expected, but not required, for a person to sleep with their head pointed toward the head end and their feet pointed toward the foot end. The wall bed 20 is supported by two lift assemblies 26 attached to opposite sides of the head end of the bed frame 22 that allow the bed 20 to operate, that is to fold (pivot) about the pivot axis A from the closed (vertical) position to the open (horizontal) position, and back to the closed position. The pair of lift assemblies 26 are disposed on opposite sides of the bed frame 22 along the pivot axis A.

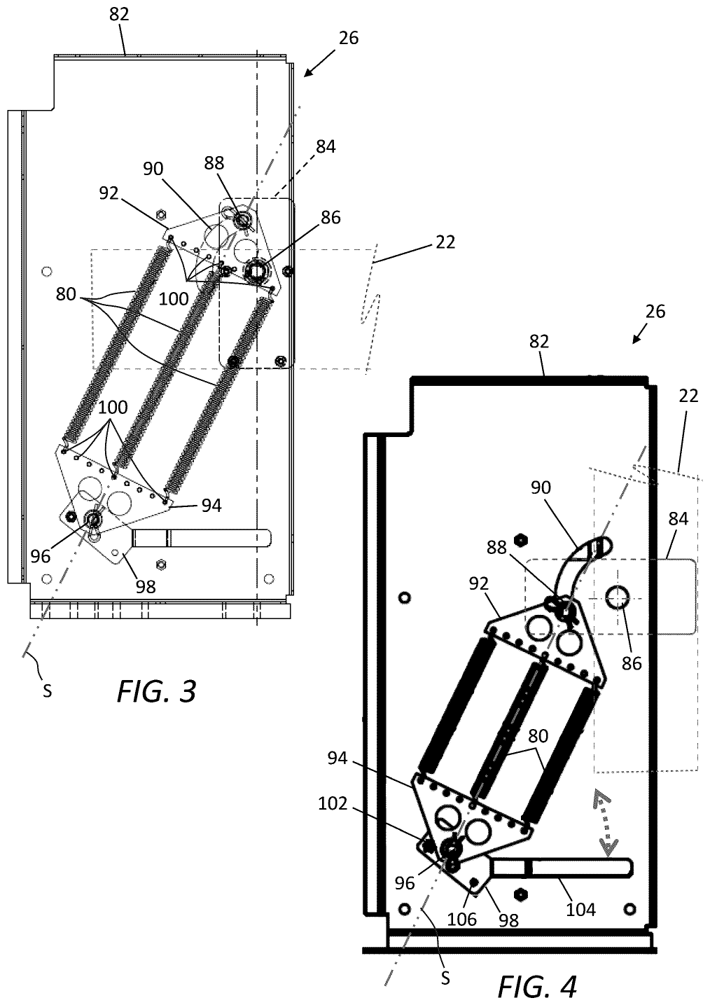

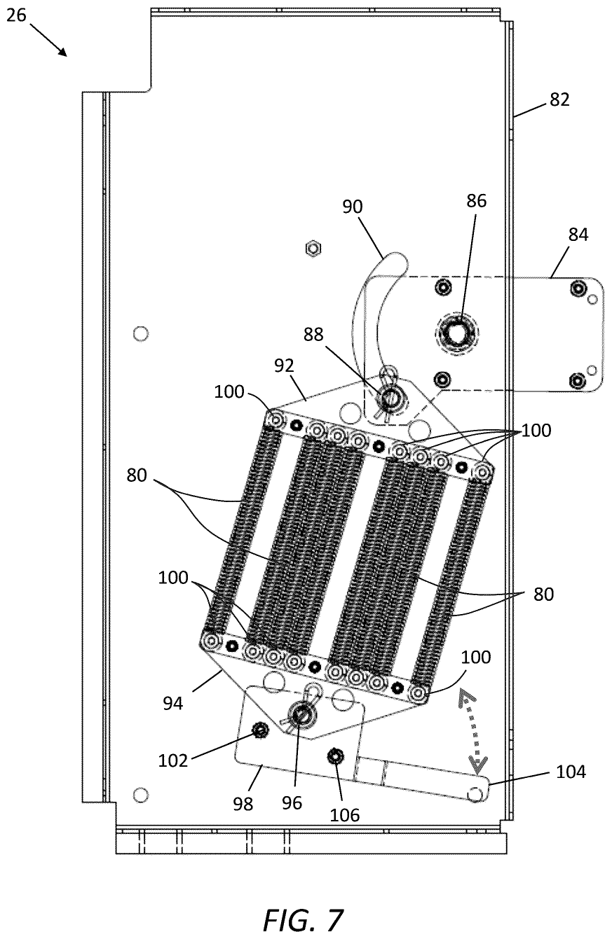

FIGS. 3-6 illustrate a first embodiment of the lift assembly 26 includes a spring-activated lift mechanism in which an adjustable number of springs 80 are arranged to urge the bed frame toward the closed, vertical position without providing so much force as to cause the bed frame 22 to pivot upwardly unless also assisted by another force, such as the assistance of a user. In this embodiment, the lift assembly 26 includes a support leg 82 that acts as a primary support to support the bed frame 22 in spaced relation above the floor. In this embodiment, the support leg 82 has the form of a housing formed by two generally flat panels that enclose the springs 80, as well as mounts 100 and tensioner 98 therefor as described hereinafter, but other shapes could be used. The second embodiment of the lift assembly 26 shown in FIG. 7 is substantially similar to the first embodiment except as otherwise described hereinafter and will not be otherwise described separately. Typically, the left lift assembly 26 is arranged in a mirror image of the right lift assembly 26. Therefore, only a single one of the lift assemblies 26 is described hereinafter, it being understood that the other lift assembly 26 is substantially the same in a mirror image.

A support bracket 84 is pivotably attached on an inner/bed side of the support leg 82 with a pivot shaft 86 and forms a pivoting lift arm for lifting the bed frame 22. The pivot shaft 86 is axially aligned with and/or defines the pivot axis A. The bed frame 22 is mounted to the support bracket 84, for example with one or more fasteners, welds, adhesives, hooks, or other mounting hardware, near the head end of the bed frame 22. In some embodiments, the support bracket 84 could be integral with and/or defined by the bed frame 22 itself. In either case, the head end of the bed frame 22 is pivotably mounted to the support leg 82 such that the bed frame 22 can pivot around the axis A from the open position to the closed position and back. The pivot shaft 84 may be journalled to either or both of the support leg 82 and the support bracket 84. In this embodiment, the pivot shaft 84 is in the form of a lug extending through a first bore through the support leg 82 and second bore through the support bracket 84. The support bracket 84 is pivotably retained on the pivot shaft 86 by retainers, such as a washer and cotter key or similar retainer, and the pivot shaft 86 is retained in the first bore by an expanded head.

A first mounting lug 88 carried by the support bracket 84 slidingly protrudes into an arcuate guide slot 90 on the inner side of the support leg 82. The guide slot 90 is preferably a circular arc section that is located a constant radial distance from the pivot shaft 86. As the bed frame 22 pivots about the axis A, the mounting lug 88 travels along the arcuate path of the guide slot 90 from an upper end of the slot 90, as seen in FIG. 3, to lower end of the slot 90, as seen in FIG. 4. The guide slot 90 preferably subtends an angle of at least 90° so that the bed 20 can traverse a 90° arc from the horizontal open position to the vertical closed position.

A first spring anchor bracket 92 is attached to the mounting lug 88 on the outer side of the support leg 82. The mounting lug 88 is journalled in the through-bore in the spring anchor bracket 92 so that the spring anchor bracket 92 can rotate about the axis of the mounting lug 88. A second spring anchor bracket 94 is mounted on the outer side of the support leg 82 a distance below the lower end of the guide slot 90 sufficient to allow opposite ends of the springs 80 to be mounted to and extend between the first and second spring anchor brackets 92 and 94. The second spring anchor bracket 94 can also pivot about a second mounting lug 96 journalled in the through-bore in the spring anchor bracket 94. The mounting lug 96 is preferably maintained in fixed position relative to the support leg 82 during use. In this embodiment, the mounting lug 96 is carried by a selectively adjustable tensioner 98 that is fixed to the support leg 82 during use of the lift assembly 26, and which can be selectively loosened and adjusted to add or remove springs 80 to the assembly 26, as discussed in further detail hereinafter. Alternatively, it is within the scope of the invention that the second spring anchor bracket 94 may be mounted directly to the housing of the support leg 82. Each spring anchor bracket 92 and 94 generally has the form of a flat triangular plate with several spring attachment mounts lined along one edge of the triangular plate and a through-bore for receiving a mounting lug therethrough in the corner opposite the spring attachment mounts. The opposite ends of each spring 80 are attached to opposing edges of the first and second spring anchor brackets 92 and 94. The springs 80 have lengths selected to cause the springs 80 to be stretched in a tensioned condition when the bed frame 22 is in the open, horizontal position. The springs 80 may have a length that causes them to be stretched less or even completely untensioned when the bed frame 22 is in the closed position.

The spacing and configuration of the spring anchor brackets 92 and 94 and the support bracket 84 relative to the guide slot 90 are arranged to help prevent the bed frame 22 from automatically pivoting out of either the vertical closed position or the horizontal open position without at least some additional force applied to the bed frame 22, for example from a user gently pushing the bed frame 22 up or down, as appropriate. To accomplish this, the second mounting lug 96 is located in a position on the outer side of the support leg 82 such that the line S defined from the first mounting lug 88 to the second mounting lug 96 forms a first secant across the guide slot 90 when the bed frame 22 is in the open position, as seen in FIG. 3, and optionally also forms a second secant across the guide slot 90 when the bed frame 22 is in the closed position, as seen in FIG. 4. Thus, when the bed frame 22 is in the horizontal, open position, the resultant tension force vector from the springs 80 is directed slightly into the inner wall of the guide slot 90 rather than being directly tangential to the guide slot 90, thereby resisting at least partially the return tensioning force for pivoting the bed frame 22 up. However, when a user provides a relatively small starting force to the pivot the bed frame 22 around the axis A, such as by pushing the bed frame 22 upwardly from the horizontal, open position, the arcuate movement of the mounting lug 88 quickly causes the line S to be tangent to the guide slot 90, thereby applying the full tension force of the springs 80 to the mounting lug 88 to pivot the support bracket 84 and bed frame 22 upwardly into the vertical, closed position. The tangent position of the line S is preferably located within about 1° to 60°, and more preferably between about 20° to 50°, and even more preferably between about 40° to 45° of rotation of the bed frame 22 up from the horizontal. In this example, the tangent point is located at about 45° rotation of the support bracket 84 from the open position to the closed position. Because the springs 80 help pivot the bed frame 22 up, and likewise help prevent the bed frame 22 from making a free fall pivot down, the lift assembly 26 reduces the amount of work a user must input to move the bed 20 either up or down.

In addition, the lift assembly 26 can be readily adjusted to provide either more or less assisting force from the springs 80, thereby allowing the lift assembly 26 to be fine-tuned to provide a desired amount of lift assist for beds of different sizes and weights and/or to fit the preferences of different users. For example, the lift assembly 26 can be adjusted to balance the amount of assist provided by the springs 80 so that the spring force provided thereby is sufficient to rotate the bed frame 22 and mattress 24 up from the open position to closed position without additional force provided by the user once the mounting lug 88 moves along the guide slot 90 such that the line S is tangent to the arc of the guide slot 90 but not so strong as to be able to rotate the bed frame 22 up to the tangent position from the horizontal open position without some additional starting force, such as from a user (or a motor). To accomplish this, each of the spring anchor brackets 92 and 94 includes at least one, and preferably several releasable spring attachment mounts 100 to which the ends of the springs 80 can be releasably mounted so that individual springs 80 be can added to or removed from the spring anchor brackets 92 and 94 to either increase or reduce the amount of tension spring force is applied between the spring anchor brackets 92 and 94. In the embodiment shown in FIGS. 3-6, each spring attachment mount 100 is in the form of an aperture through the spring anchor bracket 92 or 94. A hooked end of a spring 80 can be hooked through the aperture to mount the spring 80 to the spring anchor bracket 92 or 94 or unhooked from the aperture to dismount the spring 80. In this example, each spring anchor bracket 92 and 94 has nine such spring attachment mounts 100 disposed along the edge of the bracket (e.g., 92) facing the opposite spring anchor bracket (e.g., 94), though the use of more or fewer such spring attachment mounts 100 is also within the scope of the invention. In the embodiment shown in FIG. 7, the spring attachment mounts 100 are in the form of small pegs or hooks extending from the outer side of each spring anchor bracket 92 such that a hook at each end of each spring 80 can be hooked to or unhooked from the peg or hook to respectively mount the spring 80 to or dismount the spring 80 from the spring anchor bracket 92 or 94.

Because the springs 80 are typically very stiff and thus difficult to stretch by hand, the tensioner 98 may be provided to de-tension the springs 80 when mounting or dismounting the springs 80 to/from the spring anchor brackets 92 and 94 and then re-tension the springs 80 when the desired springs 80 have been mounted or dismounted. The tensioner 98 includes a main body that is pivotably mounted on the outer side of the support leg 82 by a pin 102, such as a bolt disposed on one side of the mounting lug 96. A handle 104 extends away from the main body on the opposite side of the mounting lug 96 so that the mounting lug 96 is disposed between the pin 102 and the handle 104. A releasable fastener 106, such as another bolt, fixes the tensioner 98 in place to the support leg 82 when not mounting or dismounting the springs 80. When it is desired to mount or dismount springs 80 to/from the spring anchor brackets 92 and 94, the releasable fastener 106 may be removed such that the main body of the tensioner 98 can rotate around the pin 102, thereby moving the second spring anchor bracket 94 a distance toward the first spring anchor bracket 92 sufficient to completely de-tension the springs 80 and allow one or more of the springs 80 to be dismounted from and/or mounted onto opposing pairs of the spring attachment mounts 100. This is typically accomplished when the bed frame 22 is in the closed position of FIG. 4 so that the pair of spring anchor brackets 92 and 94 are closest to each other so the springs 80 are in their least state of tension or even fully relaxed. After the desired springs 80 have been mounted or dismounted, the user can use the handle 104 to provide additional leverage/torque to rotate the main body of the tensioner 98 back to its fixed position and re-fix the tensioner 98 in the fixed position with the releasable fastener 106. Thus, using the tensioner 98 makes it significantly easier to balance the lift assembly 26 by adjusting the number of springs 80, and the resultant spring force, mounted between the opposing pair of spring anchor brackets 92 and 94.

In the embodiments detailed herein, the springs 80 are represented as coil springs, although other types of springs may be used in other embodiments. In some embodiments, the lift assemblies 26 may include a motor and linkages that are configured to fold (pivot) bed frame 22 downwardly from the closed position to the open position and the fold (pivot) the bed frame 22 upwardly from the open position back to the closed position. Such a motorized actuator may be provided and integrated along with the lift assemblies 26 described herein, with the lift assemblies 26 reducing the amount of power required by the motor. Shims can be used to adjust the height of the lift assemblies 26 from the floor to allow for floor and wall thickness variations.

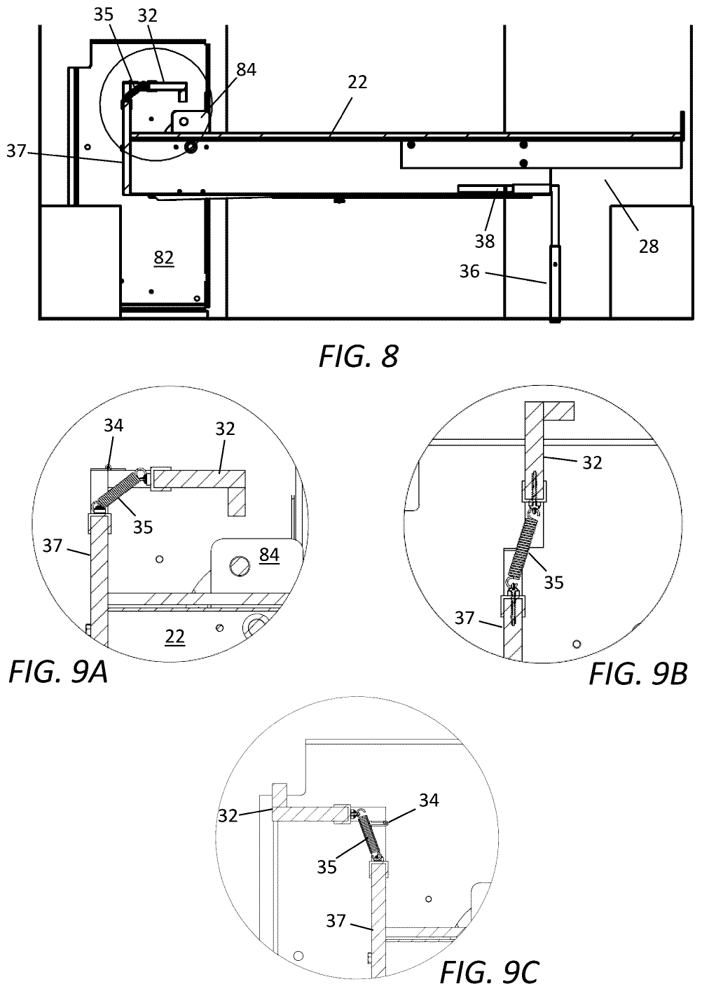

The wall bed 20 preferably also provides an under-bed storage area. To provide this, a space offset 28 is provided under the foot end of the bed frame 22, as best seen in FIGS. 2 and 8. The space offset 28 is in the form of a stepped, cutout portion of the frame 22 above various cabinetries disposed on the bottom side of the bed frame 22, which are discussed hereinafter. The space offset 28 provides space for a water storage tank, wheel well, and/or other objects. The foot end of the wall bed 20 can thus be disposed over objects in the horizontal, open position with the objects stowed underneath the foot end of the mattress 24 and bed frame 22. As seen in FIG. 1, in the closed position, the space offset 28 simply looks like a wall section above the top of the cabinetry.

A strap 30 may be provided that extends from the left side of the bed frame 22 to the right side of the bed frame 22, preferably spaced between the head end and the foot end of the bed frame 22, and over the top of the mattress 24 (and any sheets on the mattress). The strap 30 holds the mattress 24 against the bed frame 22 in the closed position. The strap 30 may also hold bed sheets against the mattress 24 and prevent the sheets from falling down into a pile at the head end of the mattress 24 when the bed frame 22 is in the upright closed position. The strap 30 can be unfastened, for example from the right side of the bed frame 22 or at a buckle on a portion of the strap extending from the right side of the bed frame 22, so that a person can fit under the covers when sleeping on the bed 20. When it is desired to return the bed frame 22 and mattress 24 to the closed position, the strap 30 is stretched over the top of the sheets and re-fastened to the right side of the bed frame 22.

As best seen in FIGS. 2, 8, and 9A-9C, a folding night shelf 32 is disposed at the head end of the bed 20 and extends from the left side of the bed frame 22 to the right side of the bed frame 22. The night shelf 32 can be rotated about a hinge 34 that extends laterally across the head end of the bed 20 between a storage position as shown in FIGS. 8 and 9A and a use position as shown in FIGS. 2 and 9C. In the storage position, the folding night shelf 32 is folded over the sheets at the head end of the bed 20 to help keep the sheets flat against the mattress 24. In the open position, the folding night shelf 32 forms a shelf at the head end of the mattress 24 and extends from the left side of the bed frame 22 to the right side of the bed frame 22. One or more springs 35 are connected to the shelf 32 and to a headboard 37 at the head of the bed 20. The springs 35 are stretched in a state of tension in both the fully open position shown in FIG. 9A and the fully closed position shown in FIG. 9C, thereby positively urging the shelf 32 to remain in whichever of the open or closed position it is in. Thus, the spring(s) 35 also actively snap the shelf 32 into the respective open or closed position.

A pair of fold up legs 36 are disposed near the foot end of the bed frame 22. One leg 36 is disposed on each of the right side and left side of the bed frame 22 near the foot end of the bed 20. As seen in FIGS. 1, 2 and 8, when the bed frame 22 is in the horizontal, open position, the legs 36 extend downwardly from the bed frame 22 to engage the floor, thereby supporting the foot end of the bed 20. Each leg 36 has a telescoping section, such as a telescoping end section, which allows the length of the leg 36 to be adjusted. The adjustable legs 36 can be useful for when the vehicle is not parked in a side-to-side level area or if there is an uneven floor. The legs 36 are attached to the bed frame 22 spaced from the foot end of the bed frame 22 adjacent to the space offset 28. This way, the legs 36 do not interfere with the open space underneath the foot end of the bed frame 22 at the space offset. When the bed frame 22 is in the upright, closed position, each leg 36 can be rotated about a pin 38 that secures the leg 36 to the bed frame 22 into a storage position. Preferably, the leg 36 includes a locking mechanism to selectively, releasably lock the leg 36 in the downward position when the bed frame 22 is in the open position to prevent unwanted collapse of the leg. In this example, the locking mechanism includes a square end of the leg 36 that fits into a corresponding square recess in the bed frame 22. When it is desired to move the leg 36 from its use position to its storage position, the square end of the leg 36 is pulled out of the square recess along the pin 38 and then rotated about the pin 38 until the leg 36 is parallel with a cross beam portion of the bed frame 22 above the cabinetry. Then, the pin 38 and square end of the leg 36 are shifted back into the square recess to again lock the leg 36, this time in its storage position.

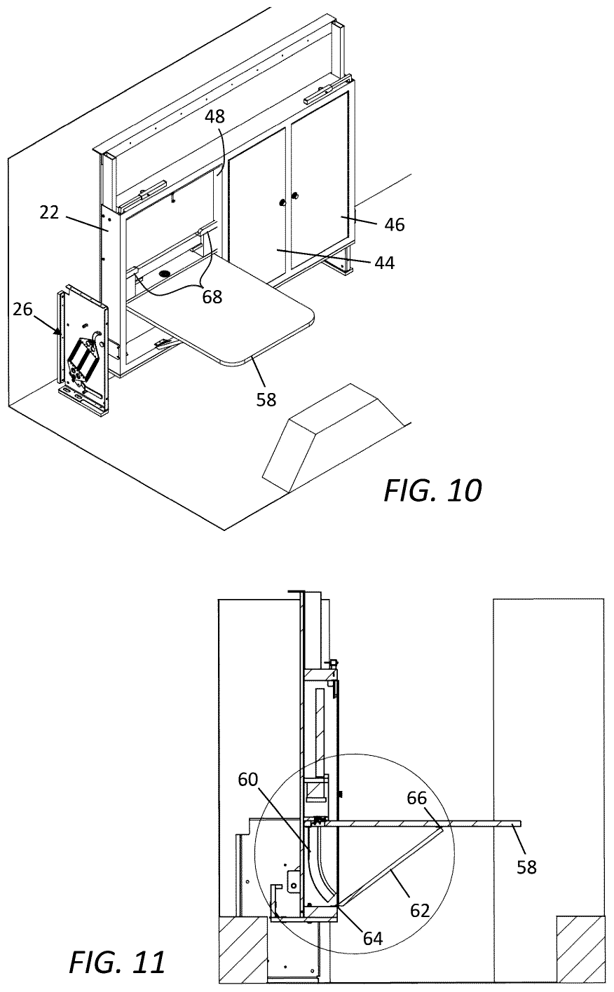

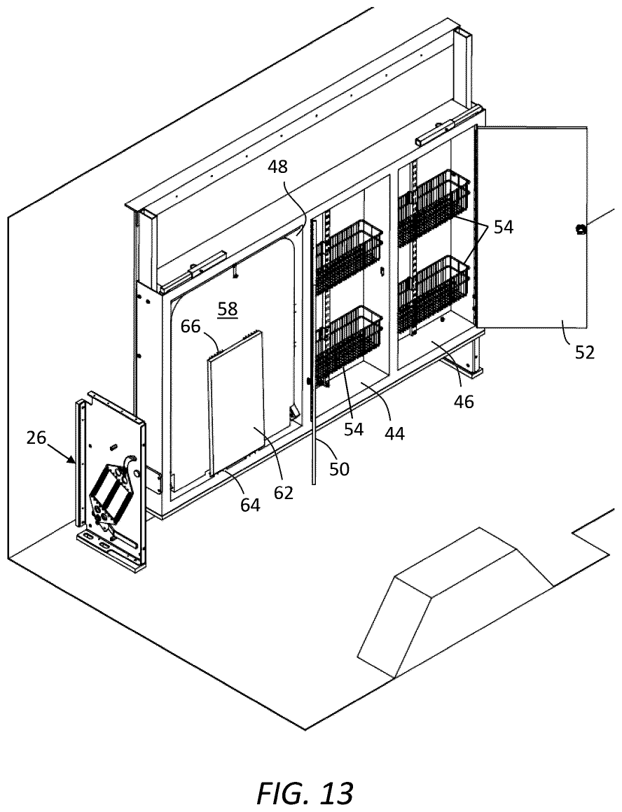

As best seen in FIGS. 1 and 10-13, various cabinetry is disposed on the bottom side of the bed frame 22 so as to face the interior of the room (e.g., the van cargo area) when the bed frame 22 is in the closed position and to face the floor when the bed frame 22 is in the open position. Thus, when the bed frame 22 is in the open position, the cabinetry is disposed underneath the bed 20. As represented in FIG. 13, the wall bed 20 preferably includes captured enclosed shelving, such as baskets, for storage. In some nonlimiting aspects of the invention, the wall bed 20 may also provide space for an entertainment center, such as a television and/or audio equipment. While the cabinetry may be provided in an almost unlimited number of different forms, in this nonlimiting example, the cabinetry includes a pair of storage cabinets 44 and 46 along the right side of the bed frame 22 and an entertainment center cabinet 48 disposed on the left side of the bed frame 22 that contains an entertainment center, such as a television and/or audio equipment, as represented in FIG. 10.

As best seen in FIG. 13, the left cabinet 44 is formed within a thickness of the top, bottom, and two center support beams of the bed frame 22. A cabinet door 50 is attached to the bottom edge of the left center support beam with one or more hinges to close the left cabinet 44. The right cabinet 46 is similarly formed within a thickness of the top, bottom, right center, and right support beams of the bed frame 22. A second door 52 is attached to the bottom edge of the right support beam with one or more hinges to close the right cabinet 46. One or more adjustable basket shelves 54 are disposed inside each of the left cabinet 44 and the right cabinet 46. Each basket shelf 54 is in the form of an elongate basket with a bottom wall, four side walls, and an open top, and can be releasably attached to one or more brackets along the back of the cabinet. The cabinet doors 50 and 52 are spaced in close proximity to the basket shelf 45 so that the doors trap and keep items in the baskets in place when the bed 20 is in the horizontal, use position. A hanger rod may be provided near the top end of the left cabinet 44 from which clothing may be hung with clothes hangers.

As best seen in FIGS. 10-12C, a fold-down door 58 that closes the entertainment center cabinet 48 forms a horizontal table when opened. The fold-down door 58 is slidingly received within a pair of curved wheel tracks 60 disposed on opposite left and right sides of the fold-down door and carried by the opposing faces of the left and center left support beams of the bed frame 22. For example, a track follower 56, such as a small wheel (truck), disposed on each of the left and right sides of the fold-down door 58 may be disposed in the respective left and right curved tracks 60 to guide the bottom end of the fold-down door 58 between the closed position shown in FIG. 12C and the open position shown in FIG. 12A. A strut 62 pivotably couples the fold-down door 58 with the bottom cross beam (at the head end of the bed). A first hinge or set of hinges 64 pivotably connects one end of the strut 62 to the bottom cross beam, and a second hinge or set of hinges 66 pivotably connects the opposite end of the strut 62 to a central area of the fold-down door 58. Appropriate locks and/or latches may be provided to latch the fold-down door 58 in either or both of the closed position and the open position.

As evident from FIGS. 10, 11, and 13, the fold-down door 58, in the closed position, can be utilized to enclose and protect various electronic components, such as a television or radio, inside the entertainment center cabinet 48 when folded up in its closed position and provides access to the electronic components when folded down in its open position. Various locking shelves 68 inside the entertainment center cabinet 48 support and retain the electronics in a safe position inside the entertainment center cabinet 48 when the bed frame 22 is in both the upright, closed position and the horizontal, open position. Various electrical and/or data outlets may be provided inside the entertainment center cabinet 48 for providing power and/or data connections to the various electronics mounted in the various locking shelves 68

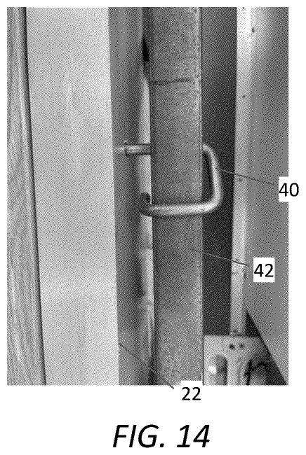

As shown in FIG. 14, in some embodiments, a latch 40 may be disposed on either or both outer sides of the bed frame 22 to selectively, releasably latch the bed frame 22 to a vertical column 42 to lock the bed frame 22 in the vertical, closed position. The latch 40 can be unlatched from the vertical column 42 when it is desired to unfold the bed frame 22 into the open position. In this nonlimiting example the latch 40 includes a stabilizing end post with a locking pin to keep the bed frame 22 in the closed position while not in use.

Various components of the fold-down wall bed 20 may be made in standard sizes that can be assembled in a modular manner. Thus, the lift assemblies 26 may be used to support bed frames of different sizes. Similarly, additional or fewer storage compartments may be implemented underneath the bed 20, and the components in the storage compartments may be modular.

As previously noted above, though the foregoing detailed description describes certain aspects of one or more particular embodiments of the invention, alternatives could be adopted by one skilled in the art. For example, the fold-down wall bed 20 and its components could differ in appearance and construction from the embodiments described herein and shown in the drawings, functions of certain components of the fold-down wall bed 20 could be performed by components of different construction but capable of a similar (though not necessarily equivalent) function, and various materials could be used in the fabrication of the fold-down wall bed 20 and/or its components. As such, and again as was previously noted, it should be understood that the invention is not necessarily limited to any particular embodiment described herein or illustrated in the drawings.

1. A fold-down wall bed comprising,
a bed frame that pivots about a lateral axis near a head end of the bed frame between an upright closed position and a horizontal open position; and
a spring-assisted lift assembly that pivots the bed frame about the lateral axis between the closed position and the open position;
wherein a closing force exerted by springs in the spring-assisted lift assembly to pivot the bed frame about the lateral axis can be adjusted by adding or removing springs to the spring-assisted lift assembly after the fold-down wall bed has been installed for use.

2. The fold-down wall bed of claim 1, wherein the spring-assisted lift assembly comprises a tensioner that can be shifted to release tension in one or more springs stretched between opposing spring anchor brackets so that one or more springs can be mounted to or removed from the opposing spring anchor brackets to adjust a closing force exerted by the one or more springs on the bed frame.

3. The fold-down wall bed of claim 2, wherein the tensioner comprises a main body pivotably mounted to a support panel and a handle extending from the main body to provide additional leverage for shifting the tensioner to re-tension the springs.

4. The fold-down wall bed of claim 1, wherein the spring-assisted lift assembly comprises:
a support leg;
a first spring anchor bracket pivotably mounted on a first lug mounted to the bed frame;
a second spring anchor bracket pivotably mounted on the support leg on a second lug;
one or more springs extending between and mounted to each of the first spring anchor bracket and the second spring anchor bracket;
wherein the one or more springs urge the bed frame to pivot about the lateral axis from the horizontal open position to the upright closed position.

5. The fold-down wall bed of claim 4, wherein the lug travels along an arcuate guide path when the bed frame pivots about the lateral axis between the upright closed position and the horizontal open position such that the one or more springs are in a first state of tension when the bed frame is in the horizontal open position with a greater tension force than a second state of tension when the bed frame is in the upright closed position.

6. The fold-down wall bed of claim 5, wherein a line defined through the first lug and the second lug form a secant across the arcuate guide path when the bed frame is in the horizontal open position.

7. The fold-down wall bed of claim 4, wherein each of the first spring anchor bracket and the second spring anchor bracket includes one or more spring attachment mounts by which a spring can be releasably mounted and/or dismounted to/from the respective spring anchor bracket.

8. The fold-down wall bed of claim 7, wherein the spring attachment mounts comprise at least one of apertures through the respective spring anchor bracket and pegs or hooks carried by the respective spring anchor bracket to which springs can be releasably mounted.

9. The fold-down wall bed of claim 1, further comprising a fold-down door pivotably coupled to the bed frame, wherein the fold down door slides along a curved track and pivots about a strut to shift between a closed position and an open position that forms a table.

10. The fold-down wall bed of claim 1, further comprising an entertainment center cabinet including lockable shelving to which electronic devices can be securely mounted and maintain the electronic device stable when the bed frame is in both the closed position and the open position.

11. The fold-down wall bed of claim 1, further comprising a space offset at a foot end of the bed frame opposite the head end, wherein the space offset defines an under-bed storage area at the foot end of the bed frame when the bed frame is in the open position.

12. The fold-down wall bed of claim 1, further comprising a strap configured to hold a mattress against a top side of the bed frame.

13. The fold-down wall bed of claim 1, further comprising a folding night shelf disposed along the head end of the bed frame, wherein the folding night shelf rotates between a use position and a storage position, and a spring releasably holds the folding night shelf in each of the use position and the storage position.

14. The fold-down wall bed of claim 1, further comprising a leg for supporting the foot end of the bed frame in the open position, wherein the leg can be shifted between a use position that extends downwardly from the bed frame in the open position and a storage position along the bed frame in the closed position.

15. The fold-down wall bed of claim 14, wherein the leg includes a telescoping portion that allows the length of the leg to be selectively adjusted.

16. The fold-down wall bed of claim 1, further comprising:
a vertical column adjacent a side of the bed frame in the closed position; and
a latch that releasably locks the bed frame to the vertical column in the closed position.

17. The fold-down wall bed of claim 1, further comprising:
a storage cabinet disposed on a bottom side of the bed frame in the open position; and
basket shelves disposed inside the storage cabinet.

18. A method of balancing the fold-down wall bed of claim 1, the method comprising:
adding or removing springs to the spring-assisted lift assembly to balance the closing force such that the closing force is sufficient to rotate the bed frame up from the open position to the closed position without additional force after the bed frame has pivoted past a tangent position on an arc of a guide slot but not sufficient to rotate the bed frame up to the tangent position from the horizontal open position without some additional starting force.

19. A spring-assisted lift assembly for pivoting a bed frame of a fold-down wall bed about a lateral axis between a closed position and an open position, the spring-assisted lift assembly comprising:
a first spring anchor bracket pivotably mounted on a first lug to be secured to the bed frame;
a second spring anchor bracket pivotably mounted on a second lug secured to a support leg;
one or more springs extending between and releasably mounted to each of the first spring anchor bracket and the second spring anchor bracket;
wherein the one or more springs urge the first lug travel in an arcuate path about the lateral axis for moving the bed frame from the horizontal open position toward the upright closed position; and
wherein a closing force exerted by springs in the spring-assisted lift assembly can be adjusted by adding or removing springs to the spring-assisted lift assembly.

20. The spring-assisted lift assembly of claim 19, wherein the spring-assisted lift assembly comprises a tensioner that can be shifted to release tension in the one or more springs stretched between the first and second spring anchor brackets so that one or more springs can be mounted to or removed from the spring anchor brackets to adjust the total closing force exerted by the one or more springs on the bed frame.
